(19) United States
(12) Patent Application Publication
(10) Pub. No.: US 2019/0170857 A1
(43) Pub. Date: Jun. 6, 2019

(54) RADAR TRANSCEIVER

(71) Applicant: DENSO CORPORATION, Kariya-city (JP)

(72) Inventors: Kensuke NAKAJIMA, Kariya-city (JP); Shinji YAMAURA, Kariya-city (JP)

(21) Appl. No.: 16/268,571

(22) Filed: Feb. 6, 2019

Related U.S. Application Data
(63) Continuation of application No. PCT/JP2017/020850, filed on Jun. 5, 2017.

(30) Foreign Application Priority Data
Aug. 10, 2016 (JP) 2016-157647

(51) Int. Cl. G01S 7/35

(52) U.S. Cl. CPC G01S 7/354; G01S 13/931; G01S 2007/358

(57) ABSTRACT

A radar transceiver may include a noise canceller. The noise canceller may include a phase shifter circuit, a variable gain amplifier, and a coupler circuit. The phase shifter circuit may shift (i) a phase of a modulated signal, (ii) a phase of an original signal, or (iii) a phase of a signal generated by a noise cancellation signal generator circuit having a frequency corresponding to a frequency of a reflected signal which is reflected by an obstacle. The variable gain amplifier may amplify or attenuate a noise cancellation signal. The coupler circuit may couple the noise cancellation signal with a received signal from a receiver. An amplitude of the noise cancellation signal may be controlled by a controller via the variable gain amplifier. A phase shift amount of the noise cancellation signal may be controlled by the controller via the phase shifter circuit.

### CROSS REFERENCE TO RELATED APPLICATIONS

The present application is a continuation application of International Patent Application No. PCT/JP2017/020850 filed on Jun. 5, 2017, which designated the U.S. and claims the benefit of priority from Japanese Patent Application No. 2016-157647 filed on Aug. 10, 2016. The entire disclosures of all of the above applications are incorporated herein by reference.

### TECHNICAL FIELD

The present disclosure relates to a radar transceiver.

### BACKGROUND ART

Recently, many technologies such as collision prevention, autonomous driving and the like have been proposed. For the technologies, a technique for measuring a distance from a device to a target using the radar has attracted attention.

### SUMMARY

A radar transceiver may include a noise canceller. The noise canceller may include a phase shifter circuit, a variable gain amplifier, and a coupler circuit. The phase shifter circuit may shift (i) a phase of a modulated signal, (ii) a phase of an original signal, or (iii) a phase of a signal generated by a noise cancellation signal generator circuit having a frequency corresponding to a frequency of a reflected signal which is reflected by an obstacle. The variable gain amplifier may amplify or attenuate a noise cancellation signal. An amplitude of the noise cancellation signal may be controlled by a controller via the variable gain amplifier. A phase shift amount of the noise cancellation signal may be controlled by the controller via the phase shifter circuit.

### BRIEF DESCRIPTION OF DRAWINGS

The above and other objects, features and advantages of the present invention will become more apparent from the following detailed description made with reference to the accompanying drawings. In the drawings:

FIG. 1 is a diagram schematically showing a configuration of an entire system according to a first embodiment;

FIG. 2 is an electronic configuration diagram schematically showing internal blocks according to the first embodiment;

FIG. 3 is a diagram schematically showing changes over time of a modulated frequency of a modulated signal, a noise signal frequency, and a target frequency;

FIG. 4 is a diagram showing a method for setting a frequency of a noise cancellation signal at the time of an increase in the modulated frequency when an FMCW modulation method (triangular wave) is employed;

FIG. 5 is a diagram showing a method for setting the frequency of the noise cancellation signal at the time of a decrease in the modulated frequency when the FMCW modulation method (triangular wave) is employed;

FIG. 6 is a diagram showing a method for setting the frequency of the noise cancellation signal when the frequency is modulated using a FMCW modulation method (sawtooth wave);

FIG. 7 is a flowchart schematically showing a noise cancellation processing;

FIG. 8 is an electronic configuration diagram schematically showing internal blocks according to a second embodiment;

FIG. 9 is an electronic configuration diagram schematically showing internal blocks according to a third embodiment;

FIG. 10 is an electronic configuration diagram schematically showing internal blocks according to a fourth embodiment; and

FIG. 11 is an electronic configuration diagram schematically showing internal blocks according to a fifth embodiment.

### DETAILED DESCRIPTION

For example, an antenna for a millimeter wave band radar for a vehicle is rarely attached to the vehicle without an obstacle between the vehicle and the target. The antenna is mostly attached inside an exterior part such as a bumper, a windshield, or the like (corresponding to the obstacle or vehicle part).

In this case, the radar transmission wave radiated from the transmission antenna does not one hundred percent pass through the exterior part, but the radar transmission wave partially reflects on the exterior part. The signal is mostly reflected from a distance of a few centimeters, so that attenuation of the reflected signal is small. When the reception antenna receives the reflected signal, a proportion of the electric power of the reflected signal to the electric power of the total received signal increases.

As an example of a technique for canceling this type of reflected noise, a radar device controls a phase of a radio wave by subtracting a second leak component from a first leak component. The first leak component indicates a wave reflected by an object, which is located outside the vehicle and other than the target. The second leak component indicates the radio wave leaks from a receiver to a transmitter.

For example, in the above-described radar device, there is a difficulty in controlling a transmission-to-reception leakage amount since a transmission-to-reception leakage depends on a circuit structure of the transceiver, a module structure, and the like. Thus, it is difficult to generate a noise cancellation signal having an optimum signal intensity in order to cancel a reflected noise. In addition, the radar transceiver generally suppresses the transmission-to-reception leakage. The transceiver that suppresses the transmission-to-reception leakage weakens the noise cancellation signal intensity, so that it is difficult to sufficiently cancel the reflected signal.

An example embodiment of the present disclosure provides a radar transceiver that enhances a radar detection distance and a radar detection capability by sufficiently cancelling a signal reflected by an obstacle.

In an example embodiment of the present disclosure, a controller controls an amplitude of the noise cancellation signal via the variable gain amplifier, and controls a phase shift amount of the noise cancellation signal via the phase shifter circuit. With this configuration, the noise cancellation signal cancels the signal reflected by the obstacle based on the signal in which a coupler circuit couples the noise cancellation signal with the received signal.

Thus, the radar transceiver can generate the optimum noise cancellation signal and sufficiently cancel the reflected signal which is reflected by the obstacle, so that the radar transceiver can enhance a radar detection distance and a radar detection capability.

Hereinafter, the embodiments of the present disclosure will be described with reference to the drawings. In each of the embodiments described below, the same or similar reference numerals are attached to the same or similar configuration, and the description is omitted as necessary. In each of the embodiments described below, the same reference numerals in both tens place and ones place are attached to the same or similar configuration. Hereinafter, a configuration applied to a millimeter wave radar using a beam forming technique will be described.

### First Embodiment

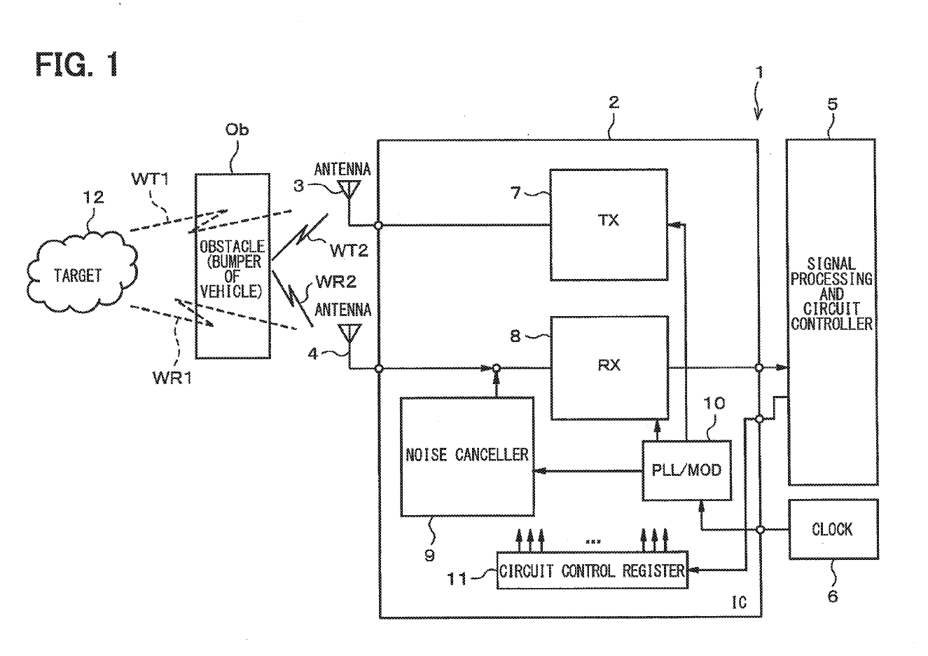

FIG. 1 to FIG. 7 show explanatory drawings of the first embodiment. FIG. 1 schematically shows a configuration of the entire system. A millimeter wave radar system 1 includes a one-chip-type transceiver mounted IC (corresponding to a radar transceiver) 2, a transmission antenna 3, a reception antenna 4, a controller 5, and a reference oscillator 6. The transmission antenna 3 may be provided by multiple antenna elements such as planar antennas constituted by patch antennas, and transmits radar waves. The reception antenna 4 may be provided by the planar antennas constituted by the patch antennas, and receives the radar waves. Although not shown in the drawings, the antenna elements of the transmission antenna 3 and the reception antenna 4 are arranged in parallel so as to obtain an intended antenna gain and antenna radiation pattern. The transceiver mounted IC 2 and the controller 5 may be integrally formed as one chip. Alternatively, the transceiver mounted IC 2 and the controller 5 may be separated from one another.

The controller 5 and the reference oscillator 6 using a crystal oscillator are connected to the transceiver mounted IC 2. The reference oscillator 6 generates an oscillation signal having a certain reference frequency, and transmits the oscillation signal to a modulated signal generator circuit 10 of the transceiver mounted IC 2. The reference oscillator 6 may transmit the oscillation signal to a noise canceller 9, in particular to the noise cancellation signal generator circuit 21, which will be described later.

The transceiver mounted IC 2 includes a transmitter 7, a receiver 8, a noise canceller 9, the modulated signal generator circuit 10, and a circuit control register 11. The circuit control register 11 functions as a storage. The modulated signal generator circuit 10 in the transceiver mounted IC 2 generates a reference signal with a high accuracy using PLL (Phase Lock Loop) when receiving the oscillation signal of the reference oscillator 6. With this configuration, the modulated signal generator circuit 10 is capable of generating an original signal of a modulated signal having a predetermined frequency with a high accuracy.

A signal processing and a circuit control processing to the transceiver mounted IC 2 are executed when the controller 5 writes a parameter to the circuit control register 11. The transceiver mounted IC 2 is provided by a semiconductor integrated circuit device formed into a single chip using, for example, a silicon based semiconductor.

The millimeter wave radar system 1 is capable of transmitting the radar wave to the front of the vehicle, and performing the transmission and reception of the radar wave having a millimeter wave band (for example, 80 GHz band: 76.5 GHz). In the millimeter wave radar system 1, the controller 5 calculates information related to a target 12 that is located outside the vehicle and reflects the radar wave. The target 12 may be another vehicle such as a preceding vehicle, a roadside object on the road, or the like. The information related to the target 12 may include distance, relative speed, direction, or the like.

As shown in FIG. 1, the radar transmission wave WT1 transmitted from the transmission antenna 3 is reflected by the target 12 so that the reflected wave WR1 is generated. The reception antenna 4 receives the reflected wave WR1 as a reflected target signal. Before the transmission wave WT1 is reflected by the target 12, a part WT2 of the radar transmission wave WT1 is reflected by an obstacle Ob and a reflected wave WR2 is generated corresponding to an environment of the millimeter wave radar system 1 attached to the vehicle. The obstacle Ob may be provided by a vehicle part, such as a bumper, a windshield, or the like. The reception antenna 4 receives the reflected wave WR2 as a reflected noise signal.

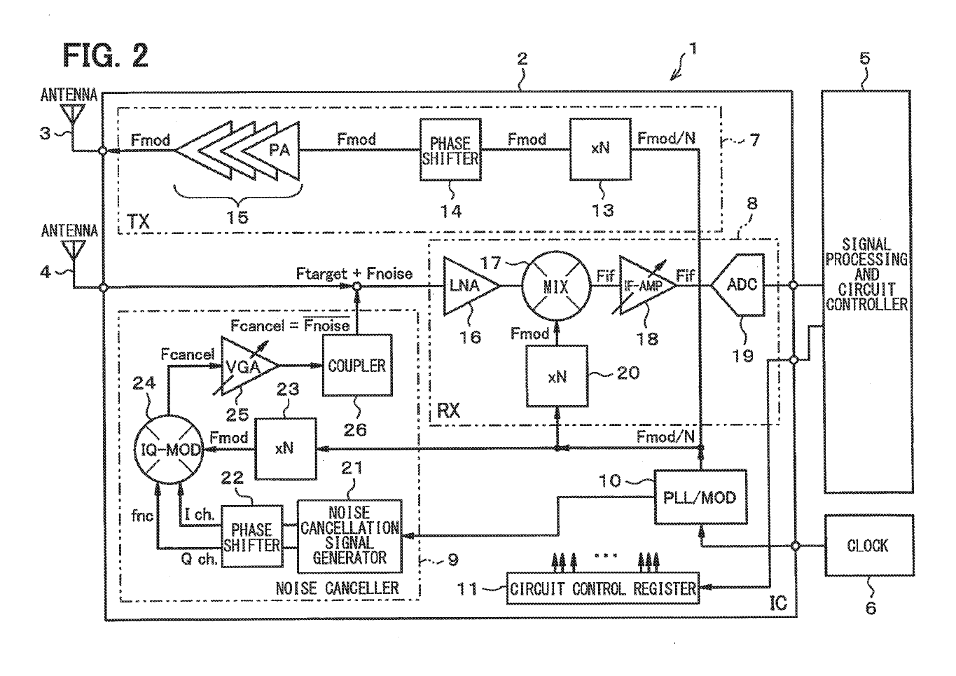

Hereinafter, the detail of the configuration according to first embodiment will be described with reference to FIG. 2. The modulated signal generator circuit 10 receives the oscillation signal generated by the reference oscillator 6, and generates the original signal of the modulated signal with a high accuracy. When generating the original signal of the modulated signal, the modulated signal generator circuit 10 gradually increases or gradually decreases the frequency of the original signal of the modulated signal in the predetermined frequency band by a predetermined modulation method (for example, FMCW modulation method). In the original signal of the modulated signal, the frequency is adjusted to Fmod/N. N indicates a multiplication number determined by an N multiplier circuit 13 or the like. The modulated signal generator circuit 10 transmits the original signal of the modulated signal to the transmitter 7, the receiver 8, and the noise canceller 9.

In the present embodiment, the modulated signal generator circuit 10 generates the original signal by gradually increasing or gradually decreasing the divided modulated signal using the predetermined modulation method. Alternatively, the modulated signal generator circuit 10 may employ the modulated signal instead of the original signal of the modulated signal. Alternatively, the modulated signal generator circuit 10 may generate a signal by multiplying the modulated signal as the original signal.

The transmitter 7 includes the N multiplier circuit 13, a phase shifter circuit 14, and an amplifier 15. The N multiplier circuit 13 generates the modulated signal by multiplying the original signal by N. The phase shifter circuit 14 shift the phase of the modulated signal transmitted from the N multiplier circuit 13. The amplifier 15 amplifies the signal transmitted from the phase shifter circuit 14. The transmitter 7 transmits the amplified signal transmitted from the amplifier 15. The N multiplier circuit 13 multiplies the signal transmitted from the modulated signal generator circuit 10 by N, so that the N multiplier circuit 13 generates the signal having a modulation frequency Fmod. The phase shifter circuit 14 shifts the phase of the multiplied signal and the amplifier 15 amplifies the phase-shifted signal. Thus, the transmitter 7 transmits the signal having the modulation frequency Fmod.

The transmission signal of the transmitter 7 is transmitted outside through the transmission antenna 3 as the radar transmission wave. The phase shifter circuit 14 shifts the phase of the signal transmitted from the N multiplier circuit 13. Although schematically shown in FIG. 1, the transmitter 7 may be connected to each of the multiple antenna elements constituting the transmission antenna 3. The phase shifter circuit 14 is capable of shifting the phase corresponding to each of the multiple antenna elements, and adjusting the transmission antenna beams.

The receiver 8 includes a low noise amplifier 16, a mixer 17, an intermediate frequency amplifier 18, an A/D converter 19, and an N multiplier circuit 20. The receiver 8 receives a signal through the reception antenna 4. The low noise amplifier 16 amplifies the received signal with a predetermined amplitude and transmits the amplified signal to the mixer 17. The N multiplier circuit 20 multiplies the original signal Fmod/N transmitted from the modulated signal generator circuit 10 by N, and transmits the modulated signal Fmod to the mixer 17.

The mixer 17 is provided as a frequency converter circuit. The mixer 17 mixes the output signal of the low noise amplifier 16 and the modulated signal transmitted from the N multiplier circuit 20, and transmits the signal to the intermediate frequency amplifier 18. In the signal transmitted to the intermediate frequency amplifier 18, the frequency is converted to a low frequency, which is difference between the frequency of the signal of the low noise amplifier 16 and the frequency of the signal of the N multiplier circuit 20. The intermediate frequency amplifier 18 may be provided by a variable gain amplifier. The intermediate frequency amplifier 18 amplifies the signal with the amplitude set in the circuit control register 11, and transmits the signal to the A/D converter 19. The A/D converter 19 converts the amplified analog signal to a digital signal, and transmits the converted signal to the controller 5. The controller 5 is provided by a microcomputer having a CPU, a ROM, a RAM or the like, which is not shown in drawings. The controller 5 receives the digital data converted by the receiver 8, and executes a signal processing based on a sampled value so as to calculate the information related to the target 12.

The noise canceller 9 is provided to reduce the influence of the reflected signal by the obstacle Ob. The noise canceller 9 includes the noise cancellation signal generator circuit 21, a phase shifter circuit 22, an N multiplier circuit 23, a quadrature modulator circuit 24, a variable gain amplifier 25, and a coupler circuit 26. The noise cancellation signal generator circuit 21 receives the signal generated by the modulated signal generator circuit 10, generates a signal based on the received signal, and transmits the generated signal to the phase shifter circuit 22. When receiving an oscillation signal of the reference oscillator 6, the noise cancellation signal generator circuit 21 may generate the signal based on the oscillation signal. The noise cancellation signal generator circuit 21 transmits an I signal and a Q signal to the phase shifter circuit 22. A phase of the I signal is offset by a phase of the Q signal by 90°. Hereinafter, the frequency of the signal generated by the noise cancellation signal generator circuit 21 is defined as the frequency fnc.

The phase shifter circuit 22 shifts the phases of the I signal and the Q signal generated by the noise cancellation signal generator circuit 21, and transmits the phase-shifted signals to the quadrature modulator circuit 24. The phase shift amount of the phase shifter circuit 22 is set in the circuit control register 11 by the controller 5.

The N multiplier circuit 23 receives the original signal transmitted from the modulated signal generator circuit 10, multiplies the original signal by N, and transmits the multiplied signal to the quadrature modulator circuit 24 as a modulated signal. The quadrature modulator circuit 24 combines the modulated signal transmitted from the N multiplier circuit 23 with the I signal and the Q signal transmitted from the phase shifter circuit 22 by performing quadrature modulation, and transmits the combined signal to the variable gain amplifier 25. In the variable gain amplifier 25, the amplitude is capable of being changed by a parameter set in the circuit control register 11. The variable gain amplifier 25 amplifies the signal transmitted from the quadrature modulator circuit 24 based on the determined amplitude, and transmits the amplified signal to the coupler circuit 26. The coupler circuit 26 couples the output signal of the variable gain amplifier 25 with the signal received from the reception antenna 4.

### Technical Significance

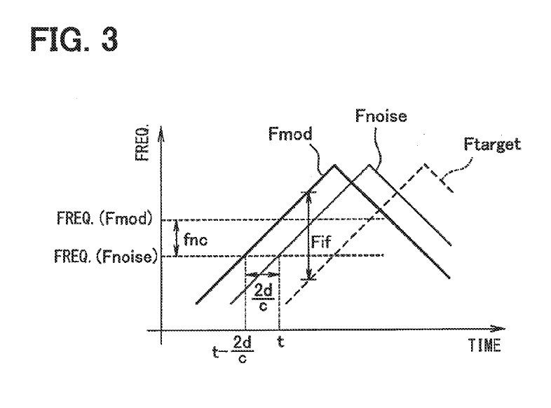

First, in the configuration described above, the technical significance of the noise canceler 9 will be described with reference to numerical formulas and FIG. 3 to FIG. 6. The radar transmission wave transmitted from the transmission antenna 3 is reflected by the obstacle Ob, and the reception antenna receives the reflected wave. The modulated signal generator circuit 10 may generate the original signal by a predetermined modulation method, such as FMCW (Frequency Modulated-Continuous Wave) modulation method. In the following description, the FMCW modulation method based on a triangular wave will be referred to as “FMCW modulation method (triangular wave)” and the FMCW modulation method based on a sawtooth wave will be referred to as “FMCW modulation method (sawtooth wave)”.

In the FMCW modulation method, the frequency of the modulated signal or the original signal is linearly increased or decreased, that is, gradually increased or gradually decreased with respect to time. In the FMCW modulation method (sawtooth wave), the frequency of the modulated signal or the original signal is linearly changed in one direction with respect to time (for example, increased), and is instantaneously changed to the reversed direction (for example, decreased direction) in a predetermined time period. With the signal modulated by such a predetermined modulation method, the frequencies can be changed between the transmission signal of the radar transmission wave and the reflected signal from the surrounding of the transmission antennas 3. Thus, the use of the modulation method can easily separate the frequency of the radar transmission wave and the frequency of the received signal, and the processing related to the information of the target 12 can be executed as accurately as possible.

As shown in FIG. 1 and FIG. 3, the radar transmission wave travels over a distance d from the transmission antenna to the obstacle Ob and a distance d from the obstacle Ob to the reception antenna 4. That is, the radar transmission wave travels for a distance 2d. Thus, a noise signal |Fnoise|, in which the radar transmission signal is reflected by the obstacle Ob and received by the reception antenna 4, is defined based on the following formula.

$$\begin{matrix}( Formula 1 ) & \\ \vert Fnoise \vert = A \cdot sin \{ 2 π f ( t - \frac{2 d}{c} ) \} & ( 1 )\end{matrix}$$

The formula 1 represents a signal of the reflected noise when a transmission signal of a frequency f is transmitted at a time point t. An amplitude A is defined as the amplitude of the signal. The frequency f is defined as the modulation frequency at the time of transmission. The distance d is defined as the distance between the transmission antennas 3 and the obstacle Ob or the distance between the reception antennas and the obstacle Ob. A velocity c is defined as the speed of light. A time point t is defined as time.

As shown in FIG. 3, at the time point t, the transmitter 7 transmits the modulated signal of the modulation frequency Fmod, and the transmission antenna 3 transmits the radar transmission wave. At the time point t, the receiver 8 receives the reflected signal reflected by the obstacle Ob of the frequency Fmod-fnc as the noise signal. The frequency fnc is defined as a frequency difference between the modulation frequency Fmod and the noise signal frequency Fnoise. The frequency fnc is calculated as fnc=Slope×2d/c. The slope Slope is defined as the gradient of the change over time of the modulation frequency Fmod, and the value is predetermined corresponding to the above-described frequency modulation method.

In other words, the noise cancellation signal is generated so as to correspond to the frequency of the reflected noise. Thus, the frequency Fcancel of the noise cancellation signal is defined as the following formula 2.

$$\begin{matrix}( Formula 2 ) & \\ \vert Fcancel \vert = Aa \cdot sin \{ 2 π ( f - Slope \times \frac{2 d}{c} ) t \pm φ \} & ( 2 )\end{matrix}$$

An amplitude Aa is defined as an amplitude of the noise cancellation signal. A phase φ is a set phase. In Formula 2, the distance d may be set as the distance between the transmission antennas 3 and the closet obstacle Ob (for example, the bumper) or the distance between the reception antenna 4 and the closet obstacle Ob.

In the configuration of FIG. 2, the noise cancellation signal generator circuit 21 generates the I signal and the Q signal by setting the frequency fnc of the noise cancellation signal that matches Slope×2d/c in Formula 2. That is, the noise cancellation signal generator circuit 21 generates the I signal and the Q signal as represented in Formula 3.

$$\begin{matrix}( Formula 3 ) & \\ I = cos 2 π ( Slope \times \frac{2 d}{c} ) t & ( 3 \text{-} 1 ) \\ Q = sin 2 π ( Slope \times \frac{2 d}{c} ) t & ( 3 \text{-} 2 )\end{matrix}$$

The phase shifter circuit 22 shifts the phase of each of the I signal and the Q signal for the phase φ, so that the phase shifter circuit 22 transmits the signals as represented in Formula 4.

$$\begin{matrix}( Formula 4 ) & \\ I = cos \{ 2 π ( Slope \times \frac{2 d}{c} ) t + φ \} & ( 4 \text{-} 1 ) \\ Q = sin \{ 2 π ( Slope \times \frac{2 d}{c} ) t + φ \} & ( 4 \text{-} 2 )\end{matrix}$$

The quadrature modulator circuit 24 combines the modulated signal transmitted form the N multiplier circuit 23 with the signals transmitted form the phase shifter circuit 22, so that the quadrature modulator circuit 24 transmits the signal as represented in Formula 5-1. This formula 5-1 is expanded as shown in formula 5-2 by the sum and product formula.

$$\begin{matrix}( Formula 5 ) & \\ \vert Fcancel \vert = cos 2 π F mod t \cdot cos \{ 2 π ( Slope \times \frac{2 d}{c} ) t + φ \} + sin 2 π F mod t \cdot sin \{ 2 π ( Slope \times \frac{2 d}{c} ) t + φ \} & ( 5 \text{-} 1 ) \\ = cos [ \{ 2 π ( F mod - Slope \times \frac{2 d}{c} ) \} t \cdot - φ ] & ( 5 \text{-} 2 )\end{matrix}$$

With this configuration, the noise cancellation signal generator circuit 21 transmits the noise cancellation signal having the frequency Fcancel that is lower than the modulation frequency Fmod of the modulated signal by frequency fnc=Slope×2d/c. The frequency component in the formula 5-2 matches the frequency component in formula 2. Thus, the variable gain amplifier 25 adjusts the amplitude to be equal to the amplitude Aa, and the phase shifter circuit 22 adjusts the the phase φ. With this configuration, the phase of the noise cancellation signal of the noise canceller 9 can be offset by the phase of the noise signal by 180°. With the above-described principle, the noise cancellation processing can be performed.

(Noise Cancellation Processing Corresponding to Modulation Method)

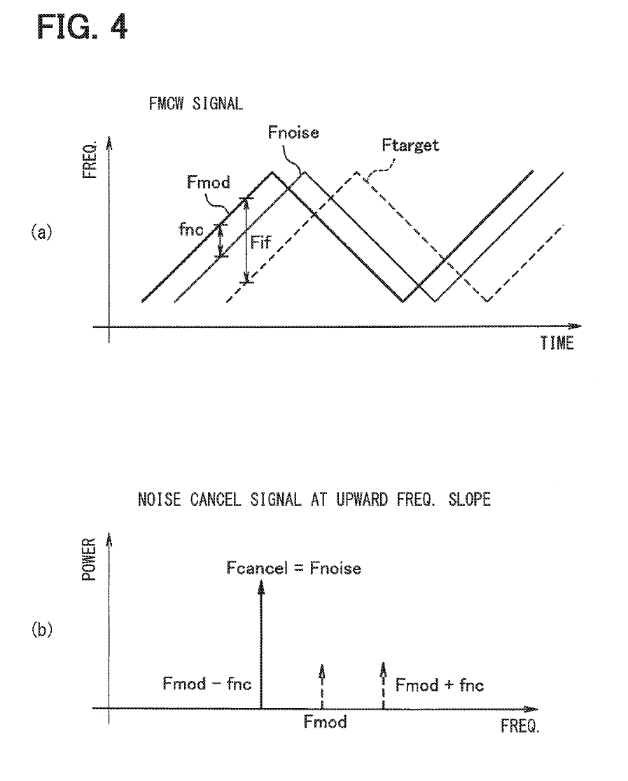

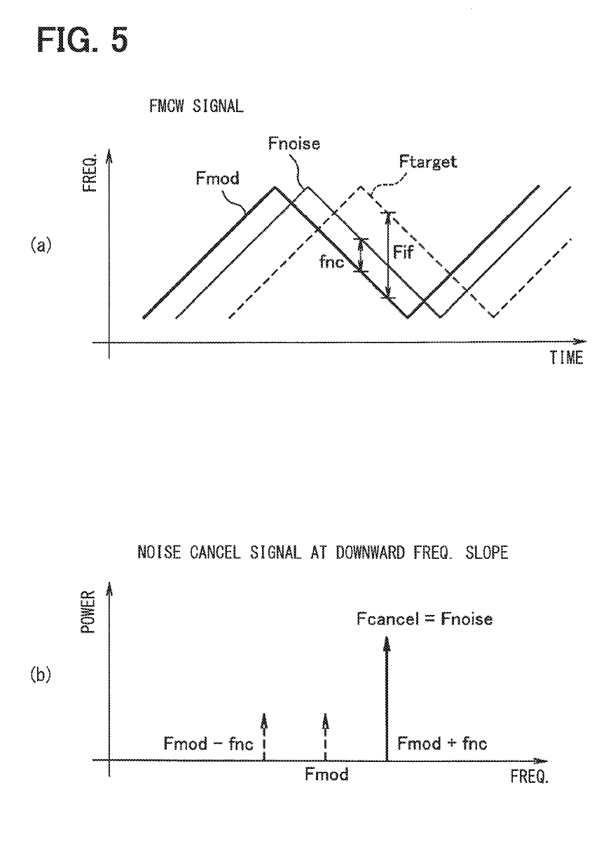

The noise cancellation processing differs corresponding to each of the modulation methods as will be described below. Each of (a) of FIG. 4 and (a) of FIG. 5 show the change over time of frequency of the noise cancellation signal using the FMCW modulation method (triangular wave). Each of (b) of FIG. 4 and (b) of FIG. 5 show the frequency spectrum of the noise cancellation signal using the FMCW modulation method (triangular wave). Particularly, FIG. 4 shows the frequency of the noise signal frequency Fnoise and the frequency spectrum of the noise cancellation signal frequency Fcancel in increasing (upward: gradually increasing) the frequency. FIG. 5 shows the frequency of the noise signal frequency Fnoise and the frequency spectrum of the noise cancellation signal frequency Fcancel in decreasing (downward: gradually decreasing) the frequency.

As shown in FIG. 4, when the FMCW modulation method (triangular wave) is employed, the frequency of the received noise signal Fnoise becomes the frequency Fmod-fnc during the gradual increase of the frequency. Thus, the noise cancellation signal generator circuit 21 generates the signal having the frequency fnc=Slope×2d/c for causing the frequency Fcancel of the noise cancellation signal to correspond to the frequency Fmod-fnc. Then, the quadrature modulator circuit 24 combines the signal transmitted from the N multiplier circuit 23 with the signal transmitted from the noise cancellation signal generator circuit 21 by performing quadrature modulation so as to cause the frequency Fcancel of the noise cancellation signal to match the frequency Fmod-fnc.

As shown in FIG. 5, when the FMCW modulation method (triangular wave) is employed, the frequency of the received noise signal Fnoise becomes the frequency Fmod+fnc during the gradual decrease of the frequency. Thus, the noise cancellation signal generator circuit 21 may generate the noise cancellation signal having the frequency Fcancel in order to correspond to the frequency Fmod+fnc.

In this case, the noise cancellation signal generator circuit 21 may transmit the I signal and Q signal by being switched with one another in regard to the gradual increase. That is, the Q signal is transmitted according to formula 4-1, and the I signal is transmitted according to formula 4-2. The quadrature modulator circuit 24 combines the modulated signal transmitted form the N multiplier circuit 23 and the signals transmitted form the phase shifter circuit 22, so that the quadrature modulator circuit 24 transmits the signal as represented in formula 6-1. This formula 6-1 is expanded as shown in formula 6-2 by the sum and product formula.

$$\begin{matrix}( Formula 6 ) & \\ \vert Fcancel \vert = cos 2 π F mod t \cdot sin \{ 2 π ( Slope \times \frac{2 d}{c} ) t + φ \} + sin 2 π F mod t \cdot cos \{ 2 π ( Slope \times \frac{2 d}{c} ) t + φ \} & ( 61 ) \\ = sin [ \{ 2 π ( F mod - Slope \times \frac{2 d}{c} ) \} t \cdot + φ ] & ( 6 \text{-} 2 )\end{matrix}$$

With this configuration, the noise cancellation signal generator circuit 21 transmits the noise cancellation signal of the frequency Fcancel that is higher than the modulation frequency Fmod of the modulated signal by frequency fnc=Slope×2d/c. The variable gain amplifier 25 adjusts the amplitude Aa and the coupler circuit 26 couples the signals. Thus, in the FMCW modulation method (triangular wave), the noise cancellation signal generator circuit 21 switches the I signal and the Q signal between the time period of gradually increasing the modulation frequency Fmod of the modulated signal and the time period of gradually decreasing the modulation frequency Fmod of the modulated signal. With this configuration, the noise canceller can transmit the desired frequency. Thus, the noise cancellation processing can be performed.

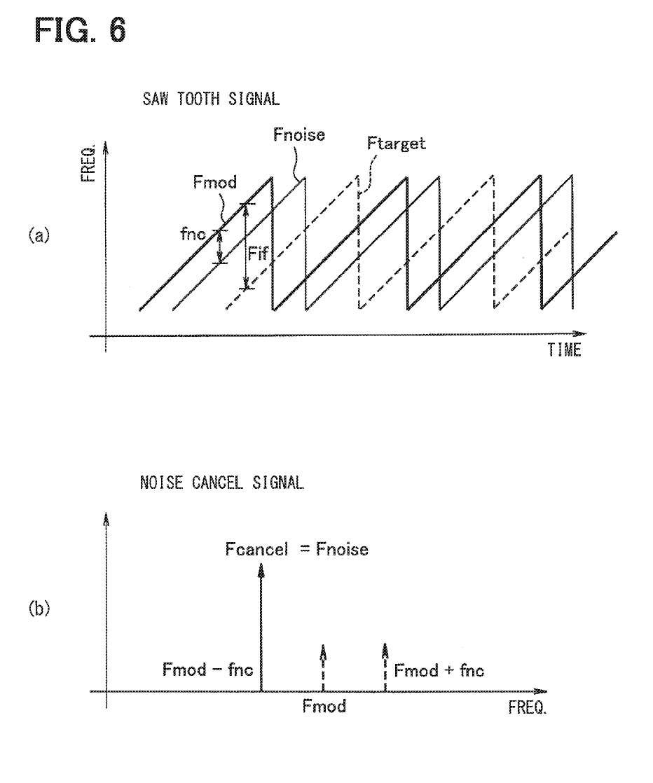

(a) of FIG. 6 shows the change over time of the modulation frequency of the noise cancellation signal using the FMCW modulation method (sawtooth wave). (b) of FIG. 6 shows the frequency spectrum of the noise cancellation signal using the FMCW modulation method (sawtooth wave). When the FMCW modulation method (sawtooth wave) is employed, the frequency is gradually increased and instantaneously decreased. In this configuration, except for the time point of the instantaneous decrease of the frequency, the noise signal frequency Fnoise becomes the frequency Fmod-fnc. Thus, when the modulation is performed using the FMCW modulation method (sawtooth wave), the noise cancellation signal generator circuit 21 generates a signal having the frequency fnc=Slope×2d/c for causing the frequency Fcancel of the noise cancellation signal to match the frequency Fmod-fnc. When the FMCW modulation method (sawtooth wave) is employed, the modulated signal frequency Fmod is only increasing (that is, gradually increasing) over time. Thus, the noise cancellation signal generator circuit 21 need not switch the I signal and the Q signal. In FIG. 6, the modulated signal frequency Fmod gradually increases over time. Alternatively, the modulated signal frequency Fmod may gradually decreases over time.

In the configuration, while the transmitter 7 transmits the modulated signal, the noise cancellation signal generator circuit 21 of the noise canceler 9 generates the signals having the frequency that corresponds to the frequency Fmod-fnc or the frequency Fmod+fnc of the reflected signal which is reflected by the obstacle Ob. Then, the phase shifter circuit 22 shifts the phase of the generated signals. The quadrature modulator circuit 24 performs the quadrature modulation to the signals transmitted from the phase shifter circuit 22 and the signal transmitted from the N multiplier circuit 23. With this configuration, the quadrature modulator circuit 24 combines the signals. The quadrature modulator circuit 24 transmits the noise cancellation signal of the frequency Fmod-fnc or the frequency Fmod+fnc to the variable gain amplifier 25, and the variable gain amplifier 25 performs the variable amplification so as to amplify or attenuates the signal. The coupler circuit 26 couples the noise cancellation signal to the signal received from the reception antenna 4. Thus, the configuration can cancel the noise.

(Parameter Setting)

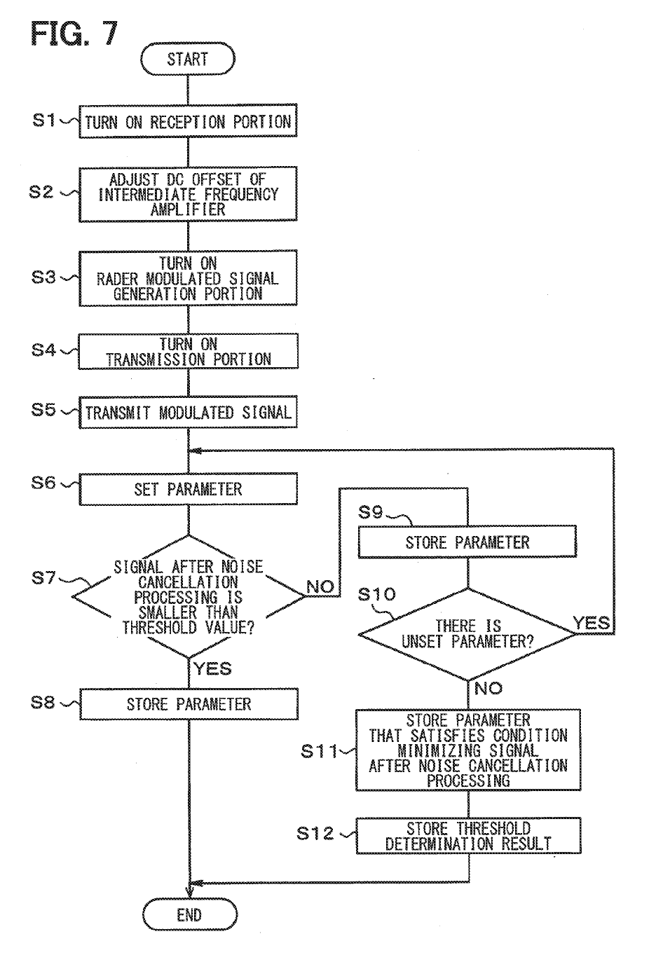

The noise cancellation processing is capable of being performed using the above-described principle and the modulation method. Hereinafter, manners for setting parameters such as the frequency Fcancel, the set phase φ, the signal amplitude Aa, or the like of the noise cancellation signal will be described with reference to the flowchart with reference to FIG. 7.

The controller 5 sets various types of parameters in the circuit control register 11. The transmitter 7, the receiver 8, and the noise canceller 9 of the transceiver mounted IC 2 are capable of adjusting, corresponding to the parameters stored in the circuit control register 11, the frequency Fmod/N of the original signal transmitted from the modulated signal generator circuit 10, the set phase φ corresponding to the phase shift amount of the phase shifter circuit 22, and the signal amplitude Aa corresponding to the amplitude of the variable gain amplifier 25. Further, the receiver 8 is capable of setting the amplitude of the intermediate frequency amplifier 18 and a DC offset corresponding to the parameters stored in the circuit control register 11.

First, the controller 5 sets the initial value of the frequency Fcancel of the noise cancellation signal of the noise canceller 9. For example, when the FMCW modulation method is employed, the initial value is set as the value defined by the frequency Fmod-Slope×2d/c. The controller 5 adjusts various types of parameters (for example, the set phase φ and the amplitude Aa), and causes the noise canceller 9 to transmit the noise cancellation signal. The frequency Fcancel of the noise cancellation signal may be offset for a predetermined value from the initial value (for example, Fmod-Slope×2d/c).

As shown in FIG. 7, in S1, the controller 5 turns on the receiver 8 and activates the operation of the receiver 8. The reflected noise component of the obstacle Ob is converted to a relatively low frequency band in the vicinity of DC, so that, in S2, the controller 5 adjusts the DC offset voltage of the intermediate frequency amplifier 18 so as to minimize the DC offset of the intermediate frequency amplifier 18. That is, the controller 5 adjusts the DC offset voltage of the intermediate frequency amplifier 18 before the reflected noise component of the obstacle Ob is received. With this configuration, the detection accuracy of the reflected noise component can be improved.

In S3 and S4, the controller 5 turns on the modulated signal generator circuit 10 and the transmitter 7, and activates the operations of the modulated signal generator circuit 10 and the transmitter 7. In S5, the controller 5 starts the transmission of the modulated signal.

In S6, the controller 5 sets the parameters in the circuit control register 11. The parameters include the modulation frequency Fmod of the modulated signal corresponding to the above-described modulation method (for example, the FMCW modulation method (triangular wave), the FMCW modulation method (sawtooth wave)), the frequency fnc, the phase φ, and the amplitude Aa. When the FMCW modulation method (triangular wave) is employed, the frequency fnc becomes Fmod±fnc (fnc=Slope×2d/c). When the controller 5 sets the initial value of the amplitude Aa of the noise cancellation signal, the controller 5 estimates the amplitude of the signal reflected by the obstacle Ob and the estimated value is applied to the initial value. The amplitude Aa is inversely proportional to the square power of the round trip distance 2d. Thus, the amplitude Aa of the noise signal can be estimated.

The controller 5 turns on the noise canceler 9, and activates the operation of the noise canceler 9. In S6, the controller 5 changes the parameters of the frequency Fmod, the frequency fnc (that is, frequency Fcancel), the amplitude Aa, and the phase φ. In S7, the controller 5 determines whether the received signal after the noise cancellation processing is performed is smaller than the predetermined threshold value. In S8, the controller 5 stores the parameter on condition that the signal is smaller than the threshold value.

When the signal after the noise cancellation processing is performed is greater than the threshold value, the controller 5 stores the parameters in S9. In S10, the controller 5 determines whether there is an unset parameter, that is, there is a parameter (for example, the amplitude Aa, the frequency Fcancel, or the like) that is capable of being adjusted. The operations S6, S7, and S9 are repeated until all of the parameters are set.

With this configuration, the controller 5 searches the parameters that minimize the signal after the noise cancellation processing is performed. In the above-described configuration, the parameters of the frequency fnc (that is, the frequency Fcancel), the phase φ, and the amplitude Aa are changed. The frequency Fcancel is uniquely determined based on the modulation frequency Fmod of the modulated signal and the distance d. Thus, the frequency Fcancel of the noise cancellation signal may be automatically calculated and two parameters of the phase φ and the amplitude Aa may be set.

For example, two parameters of the phase φ and the amplitude Aa may be changed. In this case, parameters that satisfy the minimum condition are stored according to the change of one parameter (for example, the phase φ). Then, the one parameter (for example, the phase φ) is fixed, another parameter (for example, the amplitude Aa) is changed to satisfy the minimum condition, and stores the conditions. The processing is repeated within a range satisfying the conditions for the amplitude Aa and the phase φ. The amplitude Aa may be changed within a predetermined amplitude range. The phase φ may be changed from 0 to 2n. Various types of methods such as a sequential search method or a binary search method can be employed for searching the phase φ and the amplitude Aa.

When finishing the set of all the parameters (S10: NO), in S11, the controller 5 stores the parameters that satisfy the conditions for minimizing the signal after the noise cancellation processing is performed even in a case where there is no parameters in which the signal after the noise cancellation processing is performed becomes smaller than the predetermined threshold value. In S12, the controller 5 stores the threshold determination result and terminates the processing. As a result, the optimum parameters can be derived corresponding to the noise cancellation signal generator circuit 21, the phase shifter circuit 22, and the variable gain amplifier 25 in the noise canceler 9. With this configuration, the optimum noise cancellation signal, which cancels the reflected signal which is reflected by the obstacle Ob, is capable of being generated. Thus, the cancellation amount of the reflected signal can be maximized.

### Example

An example is described below. For example, the multiplier N of the N multiplier circuit 23 is set to 2, and the frequency Fmod/N of the signal transmitted from the modulated signal generator circuit 10 is set to 40 GHz band. That is, the modulated signal frequency Fmod to be transmitted is set to the 80 GHz band. The slope of the modulation frequency of the modulated signal by time is set to 100 [MHz/μs], and the distance to the obstacle Ob is set to 30 [mm]. The product of the time t=2d/c from the transmission to the reception of the reception antenna 4 by the sloop Sloop of the modulation frequency of the modulated signal by time is calculated. In this case, the frequency Fcancel satisfies Fcancel=Slope [MHz/μs]×2d/c=100 [MHz/Ms]×30 [mm]×2/(3×10̂8)=20 [kHz]. Thus, the configuration can generate the noise cancellation signal in a practical range.

### CONCLUSION

As described above, according to the present embodiment, the coupler circuit 26 couples the noise cancellation signal with the received signal so as to cancel the reflected signal reflected by the obstacle Ob. In this configuration, the controller 5 causes the phase shifter circuit 22 to control the phase shift amount and causes the variable gain amplifier 25 to control the amplitude. Thus, the configuration can generate the optimum noise cancellation signal.

In the present embodiment, while the transmitter 7 transmits the modulated signal, the noise cancellation signal generator circuit 21 generates the I signal and the Q signal having the frequency corresponding to the frequency Fmod-fnc or the frequency Fmod+fnc of the reflected signal reflected from the obstacle Ob, and the phase of the I signal is offset by the phase of the Q signal by 90°. The phase shifter circuit 22 shifts the phase of each of the I signal and the Q signal generated by the noise cancellation signal generator circuit 21. The quadrature modulator circuit 24 performs the quadrature modulation to the I signal and the Q signal with the modulated signal of the frequency Fmod. The variable gain amplifier 25 amplifies the modulated signal. The coupler circuit 26 couples the amplified signal to the received signal. Thus, the configuration can perform the noise cancellation processing to the reflected signal reflected from the obstacle Ob.

When the modulated signal generator circuit 10 gradually increases the modulation frequency Fmod of the modulated signal, the noise canceler 9 generates the noise cancellation signal having the frequency Fmod-fnc, which is lower than the modulation frequency of the modulated signal, using the noise cancellation signal generator circuit 21 and the quadrature modulator circuit 24. The modulation frequency Fmod of the modulated signal may be gradually increased, and the frequency of the reflected signal may be lower related to the frequency of the modulated signal at the transmission time point. In this case, the configuration can generate the noise cancellation signal that is adjusted to the frequency of the received noise signal.

When the modulated signal generator circuit 10 gradually decreases the modulation frequency Fmod of the modulated signal, the noise canceler 9 generates the noise cancellation signal having the frequency Fmod+fnc, which is higher than the modulation frequency Fmod of the modulated signal, using the noise cancellation signal generator circuit 21 and the quadrature modulator circuit 24. The modulation frequency Fmod of the modulated signal may be gradually decreased, and the frequency of the reflected signal is higher related to the frequency of the modulated signal at the transmission time point. In this case, the configuration can generate the noise cancellation signal that is adjusted to the frequency of the received noise signal.

The transceiver mounted IC 2 may be provided by a semiconductor integrated circuit device formed into the single chip using a silicon based semiconductor. In this case, the design can be simplified.

The devices included in the receiver 8 are connected to the following stage of the reception antenna 4. The devices included in the receiver 8 may be the low noise amplifier 16, the mixer 17, the intermediate frequency amplifier 18. When large electric power is input to the devices 16 to 18, a large distortion may occur in the output, and there is a possibility that a desired signal cannot be normally processed.

According to the present embodiment, the noise cancellation signal is transmitted to the input terminal of the receiver 8, so that the coupler circuit 26 cancels the noise signal. With this configuration, the electric power of the reflected signal can be canceled, and the entire signal electric power received by the receiver 8 can be suppressed. Thus, the dynamic range of the receiver 8 can be expanded. As a result, the radar detection distance and radar detection capability can be enhanced. When the dynamic range of the receiver 8 can be secured, the coupler circuit 26 is not necessary to be connected to the input terminal of the receiver 8. The coupler circuit 26 may be coupled to the following stage of the low noise amplifier 16.

With the present embodiment, the circuit scale can be reduced since the circuit can be formed without a wave detector circuit 27, which will be described in a second embodiment.

### Second Embodiment

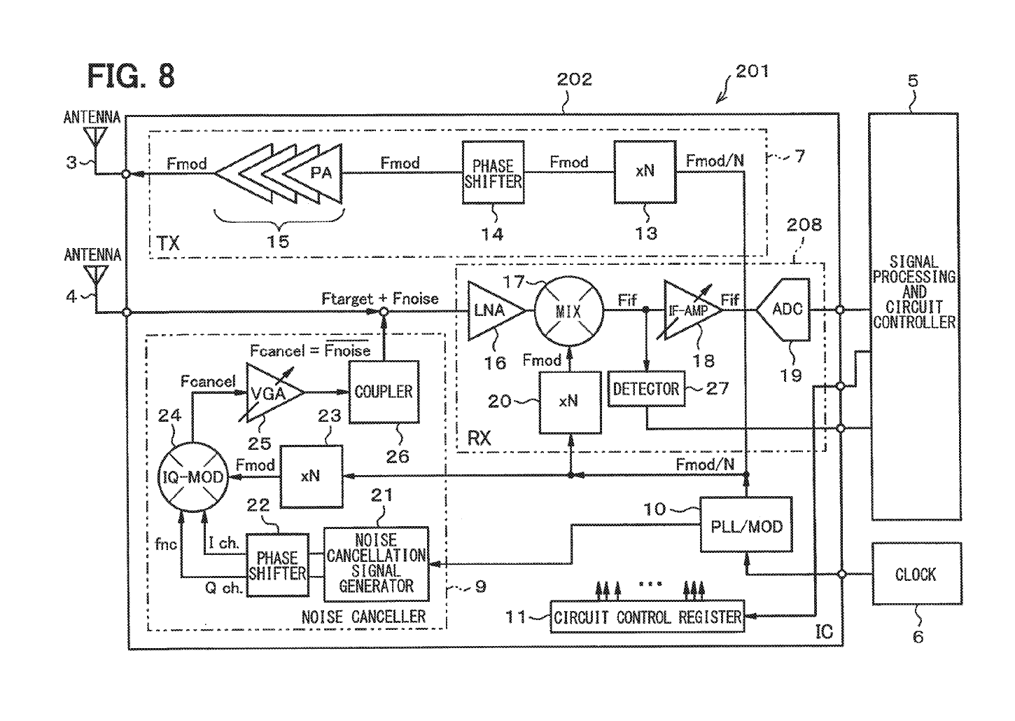

FIG. 8 shows an additional explanatory diagram according to a second embodiment. FIG. 8 shows a configuration corresponding to the configuration shown in FIG. 2 of the first embodiment. The difference of the electronic structure of FIG. 8 from the electronic structure of FIG. 2 is to include a wave detector circuit 27 as a wave detection portion that detects a signal having the intermediate frequency Fif after the processing of the mixer 17.

The mixer 17 lowers the frequency of the signal into the intermediate frequency Fif by mixing the signal after the noise canceller 9 performs the noise cancellation processing with the modulated signal. The wave detector circuit 27 filters the output signal of the mixer 17 with a low-pass filter or a band-pass filter, and outputs a filtered signal. In this configuration, the wave detector circuit 27 detects the received signal level by selectively detecting a signal having a frequency band from a signal in which the frequency is converted by the mixer 17. With this configuration, the controller 5 can directly acquire the information of the amplitude of the signal after the noise cancellation in the intermediate frequency band through the wave detector circuit 27. For example, the controller 5 can directly process the information as an analog signal.

The A/D converter 19 is connected to the following stage of the mixer 17. In the present embodiment, the cancellation effect performed by the noise canceller 9 can be determined without depending on the conversion accuracy of the A/D converter 19. In the present embodiment, the wave detector circuit 27 is connected to the following stage of the mixer 17. Alternatively, the wave detector circuit 27 may be connected to the output of the intermediate frequency amplifier 18. In this configuration, the output of the wave detector circuit 27 is monitored in order to determine the cancellation effect.

In the present embodiment, the controller 5 can control the amplitude of the noise cancellation signal via the variable gain amplifier 25 and control the phase shift amount of the noise cancellation signal via the phase shifter circuit 22. With this configuration, the cancellation effect performed by the noise canceller 9 can be determined without depending on the conversion accuracy of the A/D converter 19.

### Third Embodiment

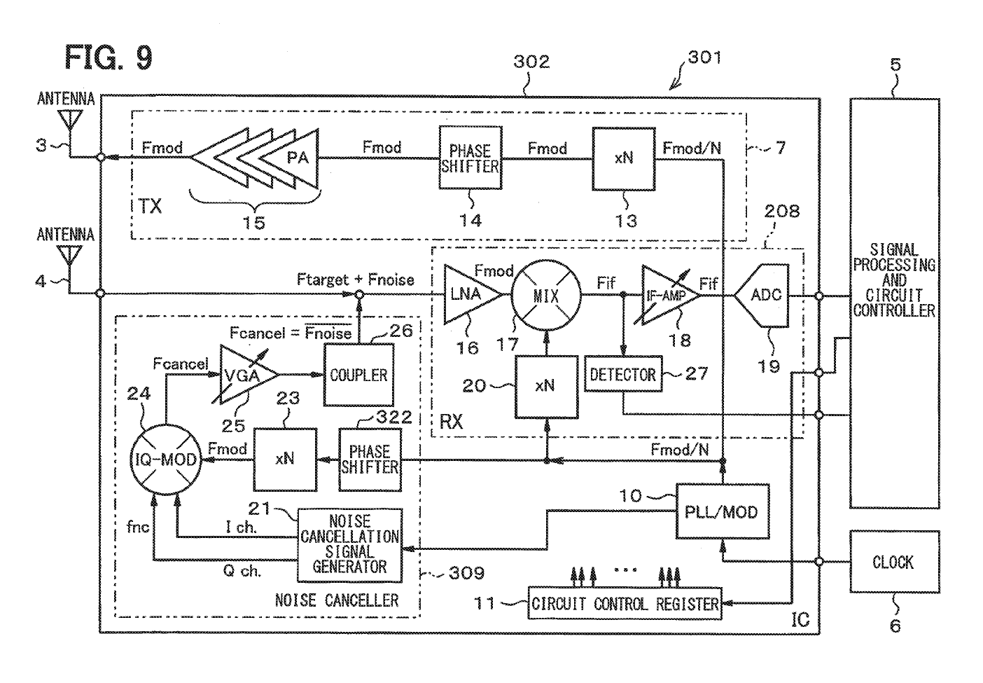

FIG. 9 shows an additional explanatory diagram according to a third embodiment. A transceiver mounted IC 302 of a radar system 301 in FIG. 9 includes a noise canceller 309. FIG. 9 corresponds to FIG. 2 of the first embodiment and FIG. 8 of the second embodiment. The configuration of FIG. 9 is different from the configuration of FIG. 8 in that a phase shifter circuit 322 of a noise canceler 309 is provided at a position different from the configuration of FIG. 8.

That is, the phase shifter circuit 322 shifts the original signal of the modulated signal having the frequency Fmod/N by the phase φ2, and outputs the signal to the N multiplier circuit 23. The N multiplier circuit 23 multiplies the output signal of the phase shifter circuit 322 by N, and transmits the multiplied signal to the quadrature modulator circuit 24 as a modulated signal having the frequency Fmod. The noise cancellation signal generator circuit 21 outputs the I signal and the Q signal to the quadrature modulator circuit 24 without passing through the phase shifter circuit 22. That is, the difference between the noise canceller 9 and the noise canceller 309 is whether the phase φ is set for the I signal and the Q signal or the phase φ2 is set for the original signal of the modulated signal.

In the case of such a circuit structure, on the mathematical expression, the phase φ will be extinguished in the formula 4-1 and formula 4-2 described above. The phase φ2 can be set to the signal of the frequency Fmod/N of the original signal of the modulated signal. Thus, on the member “cos 2π·Fmod·t” and the member “sin 2π·Fmod·t” of the formula 5-1 and formula 6-1, Fmod is replaced with Fmod/N, and the phase is shifted by the phase φ2. Further, these formulas are expanded to formulas similar to formula 5-2 and formula 6-2. Detailed description of this mathematical expression expansion will be omitted. Thus, even in this case, the noise canceller 309 can adjust the phase using the phase shifter circuit 322, and noise can be canceled for the similar reason explained in the above-described embodiment.

### Fourth Embodiment

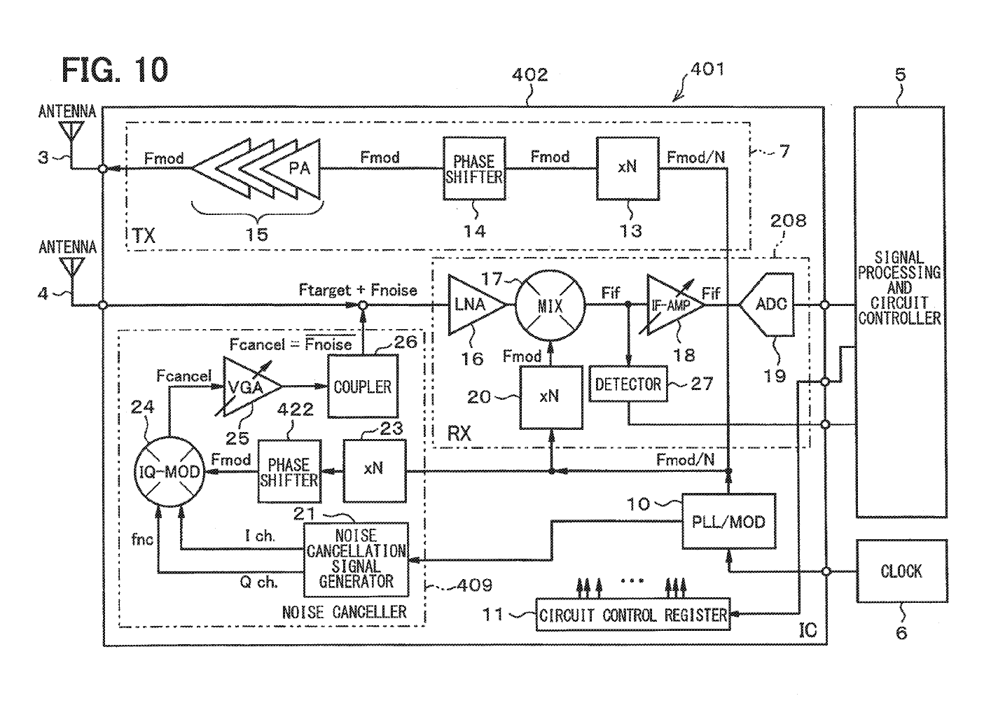

FIG. 10 shows an additional explanatory diagram according to a fourth embodiment. A transceiver mounted IC 402 of a radar system 401 in FIG. 10 includes a noise canceller 409. FIG. 10 corresponds to FIG. 2 of the first embodiment, FIG. 8 of the second embodiment, and FIG. 9 of the third embodiment. The noise canceller 409 in FIG. 10 differs from the noise canceller 309 in FIG. 9 in the arrangement of the phase shifter circuit 422 and the N multiplier circuit 23. In the noise canceller 409, after the N multiplier circuit 23 multiplies the original signal of the modulated signal by N, the phase shifter circuit 422 shifts the phase of the multiplied signal output from the N multiplier circuit 23 and transmits the shifted signal to the quadrature modulator circuit 24.

In the case of such a circuit structure, on the mathematical expression, the phase φ will be extinguished in the formula 4-1 and formula 4-2 described above. The phase φ3 can be set to the multiplied signal of the frequency Fmod. Thus, on the member “cos 2π·Fmod·t” and the member “sin 2π·Fmod·t” of the formula 5-1 and formula 6-1, the phase are shifted by the phase φ3. Further, these formulas are expanded to formulas similar to formulas 5-2 and 6-2. Detailed description of this mathematical expression expansion will be omitted. Thus, even in this case, the noise canceller 409 can adjust the phase using the phase shifter circuit 422, and noise can be canceled for the similar reason explained in the above-described embodiment.

### Fifth Embodiment

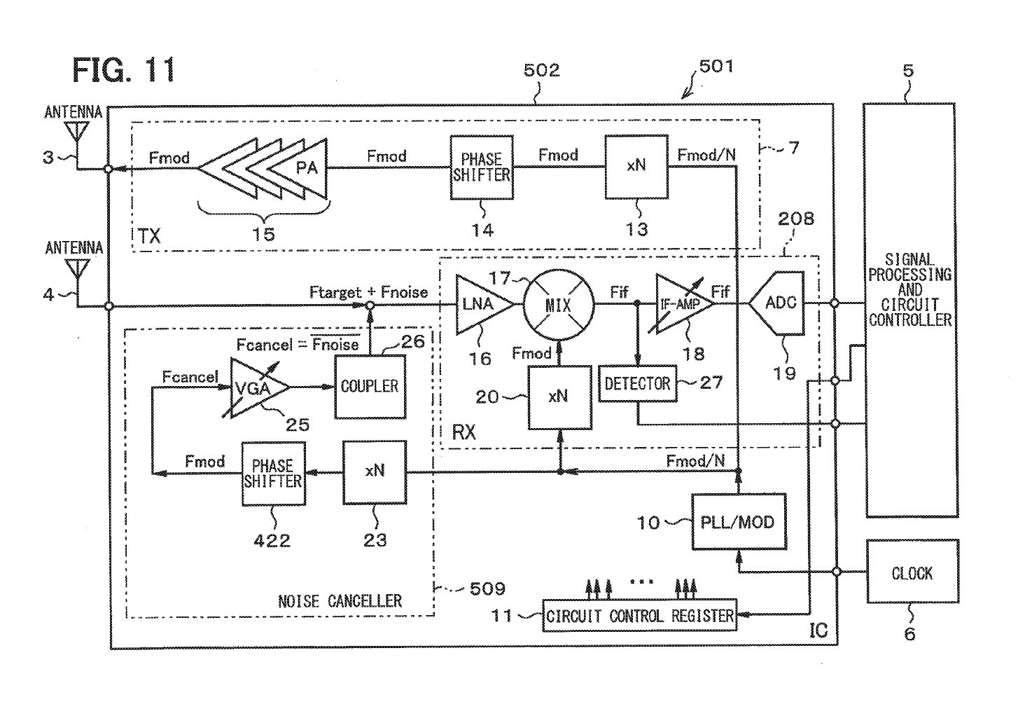

FIG. 11 shows an additional explanatory diagram according to a fifth embodiment. A transceiver mounted IC 502 of a radar system 501 in FIG. 11 includes a noise canceller 509. FIG. 11 corresponds to FIG. 2 of the first embodiment, FIG. 8 of the second embodiment, FIG. 9 of the third embodiment, and FIG. 10 of the fourth embodiment. The noise canceller 509 in FIG. 11 differs from the noise canceller 9 in FIG. 2 in the configuration without the noise cancellation signal generator circuit 21 and the quadrature modulator circuit 24.

As shown in FIG. 11, the noise canceller 509 is constituted by connecting the N multiplier circuit 23, the phase shifter circuit 422, the variable gain amplifier 25, and the coupler circuit 26 in series. The N multiplier circuit 23 multiplies the original signal of the modulated signal output from the modulated signal generator circuit 10. The phase shifter circuit 422 shifts the N-multiplied modulated signal by the set phase φ3 and transmits the shifted signal to the variable gain amplifier 25. The variable gain amplifier 25 adjusts the amplitude based on the parameter set in the circuit control register 11, and transmits the signal having amplitude Aa to the coupler circuit 26. The coupler circuit 26 couples the output signal of the variable gain amplifier 25 to the signal received from the reception antenna 4. That is, in the present embodiment, the modulation frequency Fmod of the modulated signal is equal to the frequency Fcancel of the noise cancellation signal.

In the present embodiment, the frequency Fcancel of the noise cancellation signal is equivalent to the case where fnc=Slope×2d/c=0 in the above-described formula 2. In this case, the controller 5 adjusts the amplitude Aa and the phase φ corresponding to the parameters. With this configuration, the variable gain amplifier 25 can adjusts amplitude, and the phase shifter circuit 422 can adjust the phase shift amount.

The frequency of the signal reflected by the obstacle Ob, which is located at a short distance, has a frequency, for example, equal to or less than one thousandth smaller band than the modulation frequency Fmod of the millimeter wave band modulated signal of several tens of GHz. Thus, even when the modulation frequency Fmod of the modulated signal is caused to be equal to the frequency Fcancel of the noise cancellation signal, the configuration can cancel the reflected noise.

### OTHER EMBODIMENTS

The present disclosure should not be limited to the embodiments described above, and various modifications may further be implemented without departing from the gist of the present disclosure. For example, the following modifications or extensions are possible.

The configuration is applied to, but is not limited to, the radar system 1 in the millimeter wave band. As “the modulated signal of the predetermined method”, the above-described embodiments employ, but are not limited to, the modulated signal based on the FMCW modulation method (triangular wave, sawtooth wave).

When the multiple transmission antennas 3 are provided, the same number of the transmitters 7 may be provided. When the multiple reception antennas 4 are provided, the same number of the receivers 8 may be provided, and the same number of the noise cancellers 9 may be provided. With this configuration, it is possible to individually perform noise cancellation processing of signals to be transmitted and received using the multiple transmission antennas 3 and the multiple reception antenna 4.

In the present disclosure, the target 12 is located linearly farther than the obstacle Ob. The directions of the target 12 and the obstacle Ob may be different from each other. Even when the target 12 is located closer to the obstacle Ob, the noise cancellation signal is generated corresponding to the distance d to the obstacle Ob. Thus, the same effect as described above can be obtained.

That is, two or more embodiments described above may be combined to implement the control of the present disclosure. A part of the above-described embodiment may be dispensed/dropped as long as the problem identified in the background is resolvable. In addition, various modifications of the present disclosure may be considered as encompassed in the present disclosure, as long as such modifications pertain to the gist of the present disclosure.

Although the present disclosure is described based on the above embodiments, the present disclosure is not limited to the disclosure of the embodiment and the structure. The present disclosure is intended to cover various modification examples and equivalents thereof. In addition, various modes/combinations, one or more elements added/subtracted thereto/therefrom, may also be considered as the present disclosure and understood as the technical thought thereof.

1. A radar transceiver included in a radar system, the radar system including a modulated signal generator circuit, a transmitter, and a receiver, the modulated signal generator circuit generating a radar modulated signal having a predetermined frequency band or generating an original signal from which the modulated signal is multiplied or divided, the transmitter transmitting the modulated signal through a transmission antenna, and the receiver receiving reflected signals of radar waves reflected by a target and an obstacle through a reception antenna,
the radar transceiver comprising
a noise canceller including a phase shifter circuit, a variable gain amplifier, and a coupler circuit,
the phase shifter circuit being configured to shift (i) a phase of the modulated signal, (ii) a phase of the original signal, or (iii) a phase of a signal generated by a noise cancellation signal generator circuit having a frequency corresponding to a frequency of the reflected signal which is reflected by the obstacle and received while the transmitter transmits the modulated signal,
the variable gain amplifier being configured to amplify or attenuate a noise cancellation signal generated based on an output signal of the phase shifter circuit, and
the coupler circuit being configured to output a coupled signal by coupling the noise cancellation signal from the variable gain amplifier with a received signal from the receiver,
wherein:
a controller controls an amplitude of the noise cancellation signal via the variable gain amplifier and a phase shift amount of the noise cancellation signal via the phase shifter circuit to cancel the reflected signal reflected by the obstacle based on the coupled signal,
the radar transceiver further comprising
a storage, the controller being configured to store the amplitude and the phase shift amount of the noise cancellation signal as parameters to the storage.

2. The radar transceiver according to claim 1, wherein:
the receiver includes:
a frequency converter circuit configured to mix the received signal received through the reception antenna with the modulated signal, and convert a frequency of a mixed signal; and
a wave detector circuit configured to detect a received signal level by selectively detecting a wave detection signal having a frequency band from a converted signal which is converted by the frequency converter circuit through a filter; and
the controller controls the amplitude and the phase shift amount of the noise cancellation signal via the variable gain amplifier and the phase shifter circuit based on the wave detection signal.

3. The radar transceiver according to claim 1, wherein:
the noise canceler further includes the noise cancellation signal generator circuit configured to output an I signal and a Q signal while the transmitter transmits the modulated signal, the I signal and the Q signal being generated from the signal having the frequency corresponding to the frequency of the reflected signal which is reflected by the obstacle, and a phase of the I signal is offset by a phase of the Q signal by 90°;
the phase shifter circuit shifts the phase of the I signal and the phase of the Q signal; and
the noise canceler further includes a quadrature modulator circuit configured to perform a quadrature modulation to an output I signal and an output Q signal from the phase shifter circuit using the modulated signal.

4. The radar transceiver according to claim 3, wherein
when the modulated signal generator circuit gradually increases a modulation frequency of the modulated signal, the noise canceller generates the noise cancellation signal having a frequency lower than the modulation frequency of the modulated signal using the noise cancellation signal generator circuit and the quadrature modulator circuit.

5. The radar transceiver according to claim 3, wherein
when the modulated signal generator circuit gradually decreases a modulation frequency of the modulated signal, the noise canceller generates the noise cancellation signal having a frequency higher than the modulation frequency of the modulated signal.

6. The radar transceiver according to claim 1, wherein:
the modulated signal generator circuit generates the original signal having a frequency from which a modulation frequency of the modulated signal is divided;
the noise canceller further includes a multiplier circuit configured to multiply the original signal by N; and
after the phase shifter circuit shifts the phase of the original signal, the multiplier circuit multiplies the output signal of the phase shifter circuit and the noise canceller generates the noise cancellation signal corresponding to a multiplied signal output from the multiplier circuit.

7. The radar transceiver according to claim 6, wherein
the noise canceler further includes:
the noise cancellation signal generator circuit configured to output an I signal and a Q signal while the transmitter transmits the modulated signal, the I signal and the Q signal being generated from the signal having the frequency corresponding to the frequency of the reflected signal which is reflected by the obstacle, and a phase of the I signal is offset by a phase of the Q signal by 90°; and
a quadrature modulator circuit configured to generate the noise cancellation signal by performing a quadrature modulation to the I signal and the Q signal output from the noise cancellation signal generator circuit using the multiplied signal.

8. The radar transceiver according to claim 1, wherein:
the modulated signal generator circuit generates the original signal having a frequency from which a modulation frequency of the modulated signal is divided;
the noise canceller further includes a multiplier circuit configured to multiply the original signal by N; and
after the multiplier circuit multiplies the original signal, the phase shifter circuit shifts a phase of a multiplied signal output from the multiplier circuit and the noise canceller generates the noise cancellation signal corresponding to the output signal of the phase shifter circuit.

9. The radar transceiver according to claim 8, wherein
the noise canceler further includes:
the noise cancellation signal generator circuit configured to output an I signal and a Q signal while the transmitter transmits the modulated signal, the I signal and the Q signal being generated from the signal having the frequency corresponding to the frequency of the reflected signal which is reflected by the obstacle, and a phase of the I signal is offset by a phase of the Q signal by 90°; and
a quadrature modulator circuit configured to generate the noise cancellation signal by performing a quadrature modulation to the I signal and the Q signal output from the noise cancellation signal generator circuit using the output signal of the phase shifter circuit.

10. The radar transceiver according to claim 1 provided by a semiconductor integrated circuit device formed into a single chip using a silicon based semiconductor.

11. The radar transceiver according to claim 1, wherein
the coupler circuit is connected to an input terminal of the receiver, and couples the noise cancellation signal with the received signal from the receiver.

12. The radar transceiver according to claim 1, wherein
the obstacle is provided by a vehicle part.

13. A radar transceiver included in a radar system, the radar system including a modulated signal generator circuit, a plurality of transmitters, and a plurality of receivers, the modulated signal generator circuit generating a radar modulated signal having a predetermined frequency band or generating an original signal from which the modulated signal is multiplied or divided, the plurality of transmitters transmitting the modulated signal through a plurality of transmission antennas, and the plurality of receivers receiving reflected signals of radar waves reflected by a target and an obstacle through a plurality of reception antennas,
the radar transceiver comprising:
a plurality of noise cancellers, a number of the plurality of noise cancellers being equal to a number of the plurality of reception antennas, each of the plurality of noise cancellers including a phase shifter circuit, a variable gain amplifier, and a coupler circuit,
the phase shifter circuit being configured to shift (i) a phase of the modulated signal, (ii) a phase of the original signal, or (iii) a phase of a signal generated by a noise cancellation signal generator circuit having a frequency corresponding to a frequency of the reflected signal which is reflected by the obstacle and received while each of the plurality of transmitters transmits the modulated signal,
the variable gain amplifier being configured to amplify or attenuate a noise cancellation signal generated based on an output signal of the phase shifter circuit, and
the coupler circuit being configured to output a coupled signal by coupling the noise cancellation signal from the variable gain amplifier with a received signal from each of the plurality of receivers,
wherein:
a number of the plurality of transmitters is equal to a number of the plurality of transmission antennas;
a number of the plurality of receivers is equal to a number of the plurality of reception antennas; and
a controller controls an amplitude of the noise cancellation signal via the variable gain amplifier and a phase shift amount of the noise cancellation signal via the phase shifter circuit to cancel the reflected signal reflected by the obstacle based on the coupled signal,
the radar transceiver further comprising
a storage, the controller being configured to store the amplitude and the phase shift amount of the noise cancellation signal as parameters to the storage.

14. A radar transceiver for a radar system comprising:
a modulated signal generator circuit configured to generate a radar modulated signal having a predetermined frequency band or generate an original signal from which the modulated signal is multiplied or divided;
a transmitter configured to transmit the modulated signal through a transmission antenna;
a receiver configured to receive reflected signals of radar waves reflected by a target and an obstacle through a reception antenna;
a noise canceller including a phase shifter circuit, a variable gain amplifier, and a coupler circuit;
the phase shifter circuit being configured to shift (i) a phase of the modulated signal, (ii) a phase of the original signal, or (iii) a phase of a signal generated by a noise cancellation signal generator circuit having a frequency corresponding to a frequency of the reflected signal which is reflected by the obstacle and received while the transmitter transmits the modulated signal,
the variable gain amplifier being configured to amplify or attenuate a noise cancellation signal generated based on an output signal of the phase shifter circuit, and
the coupler circuit being configured to output a coupled signal by coupling the noise cancellation signal from the variable gain amplifier with a received signal from the receiver; and
a storage configured to store an amplitude and a phase shift amount of the noise cancellation signal as parameters,
wherein:
the amplitude of the noise cancellation signal is controlled by a controller via the variable gain amplifier to cancel the reflected signal which is reflected by the obstacle based on the coupled signal; and
the phase shift amount of the noise cancellation signal is controlled by a controller via the phase shifter circuit to cancel the reflected signal which is reflected by the obstacle based on the coupled signal.
